(19) United States
(12) Patent Application Publication
(10) Pub. No.: US 2016/0044322 A1
(43) Pub. Date: Feb. 11, 2016

(54) Portable Device for Personal Electronic Health Records

(71) Applicants: Sylvain Hochberg, Chambourcy (FR); Jeffrey Dalton, Satellite Beach, FL (US)

(72) Inventors: Sylvain Hochberg, Chambourcy (FR); Jeffrey Dalton, Satellite Beach, FL (US)

(73) Assignee: Crane Business Management Professionals, Satellite Beach, FL (US)

(21) Appl. No.: 14/454,011

(22) Filed: Aug. 7, 2014

(51) Int. Cl. H04N 19/44; G06F 21/31; H04N 19/80; G06F 21/62

(52) U.S. Cl. CPC H04N 19/44; G06F 21/6245; G06F 21/31; H04N 19/80

(57) ABSTRACT

This invention relates to a portable device for storing and transporting personal electronic health records (PeHR). The device comprises a memory storage device such as a USB flash drive or SD card, an ultra low loss compression means capable of compressing and decompressing medical images and retaining their diagnostic level quality, and a security system for protecting the confidentiality of the patient information such as password protected access software or a physically lockable flash drive.

### BACKGROUND

Over the past several years there has been a great deal of interest in creating a system of electronic health records. The objective of electronic health records is to make these records more readily accessible to the several different doctors, specialists, other health care providers and insurers who see a patient in different settings and for different reasons. Furthermore, the objective of electronic health care records is to make critical information about past or current conditions or treatments known to a physician who is not able to communicate with his or her patient due to language barriers, limited capacity, or even lack of consciousness.

One problem that has arisen is that the various formats of electronic health records have not been standardized. While the Digital Imaging and Communications in Medicine (DICOM) standards have been adopted by imaging equipment manufacturers and hospitals, adoption by providers such as doctor's and dentist's offices has been limited. Furthermore, while the DICOM standard addresses technical operability and communications of medical imaging equipment, it does not address issues of clinical workflow, or communications among doctors, patients, hospitals, and other health service providers.

In addition, the size of medical image files are often quite large. Compression standards exist for image files including JPEG, JPEG2000, JPEG Lossless, and Run Length Encoding (RLE). However, these compression standards generally have low compression ratios and suffer from a significant loss of image fidelity when decompressed, in many cases the decompressed image is longer of diagnostic quality.

The security of confidential patient information is another problem. Patients are often given a CR-ROM or DVD disk with their name written on it, and medical images or other records burned onto it. This disk, if lost or stolen, contains a trove of unsecured patient information.

Finally, portability remains an issue. When a patient sees a specialist or goes from one medical practice to another, the new provider starts from a blank slate with regard to the patient's medical history. His office may or may not be able to communicate with the electronic health records system at the previous office, and so these records are orphaned.

A need exists for a device that allows a patient to possess and carry a complete copy of their electronic health records in sufficiently high quality to maintain their diagnostic quality, with sufficient security to prevent their confidential information from being compromised in the event the device is lost or stolen.

### BRIEF DESCRIPTION OF THE DRAWINGS

FIG. 1 is a diagram of known methods.

FIG. 2 is a diagram of known methods.

FIG. 3 is an example of the image encoding method using a wavelet transformed base.

FIG. 4a schematically shows different images affected by the ultra low loss compression means portion of the invention.

FIG. 4b is a flowchart of the ultra low loss compression means portion of the invention.

FIG. 5 is a schematic representation of a subset of data used in ultra low loss compression means portion of the invention.

FIG. 6 is an illustration of an exemplary application of the ultra low loss compression means portion of the invention.

### DETAILED DESCRIPTION

The present invention relates to a portable device for storing and transporting personal electronic health records (PeHR). The device comprises a memory storage device such as a USB flash drive or SD card, an ultra low loss compression means capable of compressing and decompressing medical images and retaining their diagnostic level quality, and a security system for protecting the confidentiality of the patient information such as password protected access software or a physically lockable flash drive.

An important aspect of this invention is the use of ultra low loss compression to preserve image quality even at high compression ratios. This is particularly important with respect to medical images such as x-ray images, CT scan images, and MRI images. Prior art image compression software, such as jpg and jpeg2000, lose enough image quality that x-ray images that are compressed to jpg format and then decompressed can no longer be used for diagnostic purposes. These prior art image compression formats are far inferior to the ultra low loss compression means of the present invention, and are not suitable for use in the present invention. By contrast, the ultra low loss compression means used in the present invention will allow an x-ray image to be compressed to a file size equal to or smaller than a jpg file, and yet retain its diagnostic image quality when decompressed. The ultra low loss compression means used in the present invention will allow images to be compressed to a much greater compression ratio than the current jpeg or jpeg2000 standards. Compression ratios of preferably greater than 30:1, more preferably greater than 50:1, and most preferably greater than 70:1 can be achieved by the ultra low loss compression means while maintaining the diagnostic quality of the image when decompressed.

A medical study conducted in 2004 compared the results of compression of a chest X-Ray (a 10 MB image) by the present invention and prior art techniques.

TABLE 1

| Compression type | File size | Compression ratio |
|---|---|---|
| ipg | >1000 KB | 10:1 |
| jpeg2000 | 500 KB | 20:1 |
| ultra low loss compression | 125 KB | 80:1 |

Even at the greatly increased compression ratio, the acquired, compressed, stored, and decompressed image reproduced by the present invention retained its diagnostic quality.

The most preferred embodiment of the present invention is its use as a secure device to compress, store, transport, and reproduce personal electronic health records (PeHR). In this embodiment, the ultra low loss compression means is loaded onto a PeHR portable storage device, such as a USB flash drive, an SD card, or other portable storage device that is connectable to an electronic device. In the most preferred mode the PeHR device makes a wired connection to a host computer to maintain the security of file transfer of confidential patient information. The PeHR device is also secured by a physically lockable flash drive such as the Aegis Secure Key manufactured by Apricorn in Poway, Calif. or the SecurityDR Data Guard USB Thumbdrive Lock manufactured by Digital Innovations in Arlington Heights, Ill., to maintain the security of the confidential patient information in the event the device is lost or stolen. This level of security differs from the security features taught in the DICOM standard. The DICOM (version 2013) standard allows for, but does not require, secure storage on digital media. In addition the security measures taught are those that function between the apparatus that creates the creates the data to be stored and the apparatus that reads the data. Security features that are controlled by the patient (i.e. the user) are not addressed. The security features taught by the present invention are those that can be controlled by the patient. Additional layers of data encryption may be used as well. The ultra low loss compression means is loaded onto the PeHR portable storage device in a stand-alone mode so that it does not require any software from the host computer to operate, nor does in copy its software onto the host computer. Patient records including text files, image files, database records, monitoring device records, and any other health records are selected for transfer to the PeHR device of the present invention and the image compression is performed automatically as the patient confidential information is stored on the PeHR device. Later, when the patient confidential information is retrieved, the ultra low loss image compression software de-compresses the image and other files to diagnostic quality.

Another embodiment of the present invention is its use in a device to compress, store, transport, and reproduce personal electronic health records (PeHR). In this embodiment, the ultra low loss compression means is loaded onto a PeHR portable storage device, such as a USB flash drive an SD card. In this embodiment the PeHR device makes a wired connection to a host computer to maintain the security of file transfer of confidential patient information. The PeHR device is also secured by a password protection software or dual authentication password protection software to maintain the security of the confidential patient information in the event the device is lost or stolen. Additional layers of data encryption may be used as well. The ultra low loss compression means is loaded onto the PeHR portable storage device in a stand-alone mode so that it does not require any software from the host computer to operate, nor does in copy its software onto the host computer. Patient records including text files, image files, database records, monitoring device records, and any other health records are selected for transfer to the PeHR device of the present invention and the image compression is performed automatically as the patient confidential information is stored on the PeHR device. Later, when the patient confidential information is retrieved, the ultra low loss image compression software de-compresses the image and other files to diagnostic quality.

Another embodiment of the present invention is its use in a device to compress, store, transport, and reproduce personal electronic health records (PeHR). In this embodiment, the ultra low loss compression means is loaded onto a PeHR portable storage device which is under the control of the patient, such as a cell phone, a PDA, a tablet, a laptop computer, or a smart device such as a smartwatch, or smart eyewear. In this embodiment the PeHR device makes a wired connection to a host computer to maintain the security of file transfer of confidential patient information. The PeHR device is also secured by a password protection software or dual authentication password protection software to maintain the security of the confidential patient information in the event the device is lost or stolen. Additional layers of data encryption may be used as well. The ultra low loss compression means is loaded onto the PeHR portable storage device in a stand-alone mode so that it does not require any software from the host computer to operate, nor does in copy its software onto the host computer. Patient records including text files, image files, database records, monitoring device records, and any other health records are selected for transfer to the PeHR device of the present invention and the image compression is performed automatically as the patient confidential information is stored on the PeHR device. Later, when the patient confidential information is retrieved, the ultra low loss image compression software de-compresses the image and other files to diagnostic quality.

Another embodiment of the present invention is its use in a device to compress, store, transport, and reproduce personal electronic health records (PeHR). In this embodiment, the ultra low loss compression means is loaded onto a PeHR portable storage device, such as a wireless USB flash drive, such as a SanDisk Connect Wireless Flash Drive manufactured by SanDisk Corp in Milpitas, Calif., or other wireless memory devices. In this embodiment the PeHR device makes an encrypted wireless connection to a host computer to maintain the security of file transfer of confidential patient information. The PeHR device is also secured by a password protection software to maintain the security of the confidential patient information in the event the device is lost or stolen. Additional layers of data encryption may be used as well. The ultra low loss compression means is loaded onto the PeHR portable storage device in a stand-alone mode so that it does not require any software from the host computer to operate, nor does in copy its software onto the host computer. Patient records including text files, image files, database records, monitoring device records, or other health records are selected for transfer to the PeHR device of the present invention and the image compression is performed automatically as the patient confidential information is stored on the PeHR device. Later, when the patient confidential information is retrieved, the ultra low loss image compression software de-compresses the image and other files to diagnostic quality.

Another embodiment of the present invention is its use in a device to compress, store, transport, and reproduce personal electronic health records (PeHR). In this embodiment, the ultra low loss compression means is loaded onto a wireless PeHR portable storage device which is under the control of the patient, such as a cell phone, a PDA, a tablet, a laptop computer, or a smart device such as a smartwatch, or smart eyewear. In this embodiment the PeHR device makes an encrypted wireless connection to a host computer to maintain the security of file transfer of confidential patient information. The PeHR device is also secured by a password protection software to maintain the security of the confidential patient information in the event the device is lost or stolen. Additional layers of data encryption may be used as well. The ultra low loss compression means is loaded onto the PeHR portable storage device in a stand-alone mode so that it does not require any software from the host computer to operate, nor does in copy its software onto the host computer. Patient records including text files, image files, database records, monitoring device records, or other health records are selected for transfer to the PeHR device of the present invention and the image compression is performed automatically as the patient confidential information is stored on the PeHR device. Later, when the patient confidential information is retrieved, the ultra low loss image compression software de-compresses the image and other files to diagnostic quality.

Another embodiment of the present invention is its use in a device to acquire, compress, store, decompress, and reproduce health information measured by wearable devices. Wearable devices such as the Polar Electro H6 and H7 manufactured by Polar US, Lake Success, N.Y., the Fitbit Flex manufactured by FitBit Inc, San Fransisco, Calif., the Nike Fuelband and Fuelband SE manufactured by Nike Inc, Beaverton, Oreg., the Google Fit manufactured by Google Inc, Mountain View, Calif., the Samsung Gear Fit maunfactured by Seoul, South Korea, and the Garmin Vivovolt manufactured by Garmin International, KS gather health data such as pulse rate, blood pressure, oxygen content, exercise regimen, and sleep cycles. This health data can be important to a physician evaluating or monitoring a patient's overall health. This embodiment of the present invention communicate with the wearable device wirelessly, through a wired connection to the device, or to a connection to an intermediate device such as a smartphone, tablet, or computer that is in sync with the wearable device.

The ultra low loss compression means comprises an image decoding method.

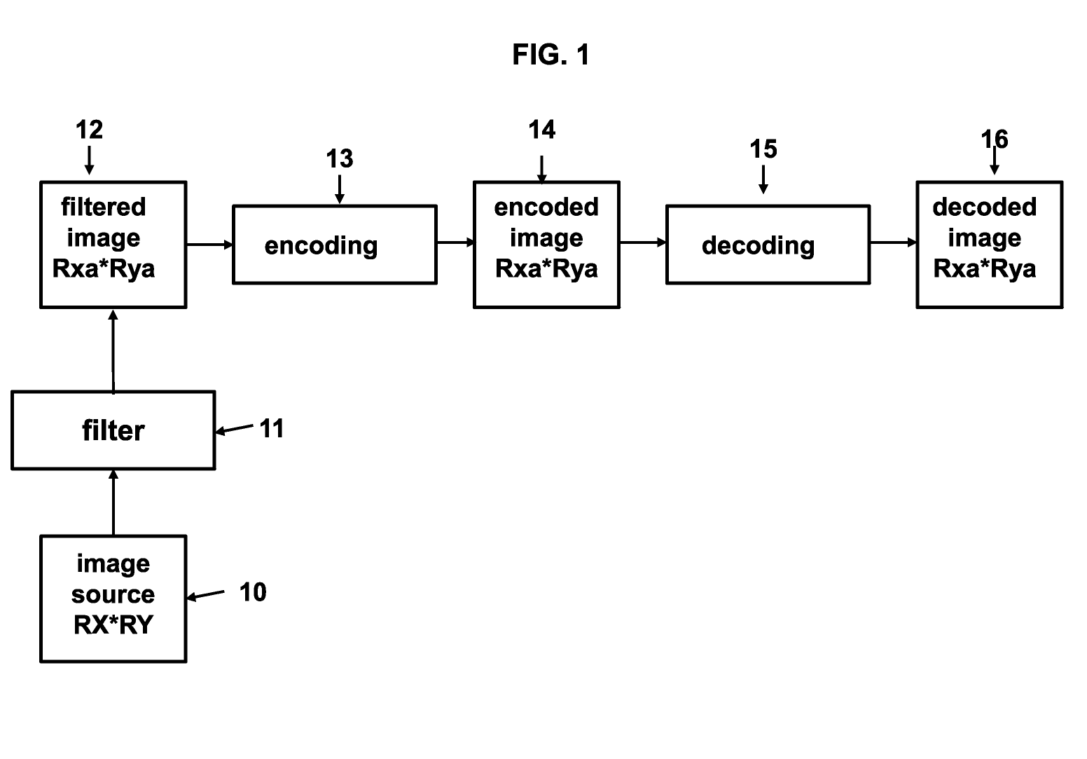

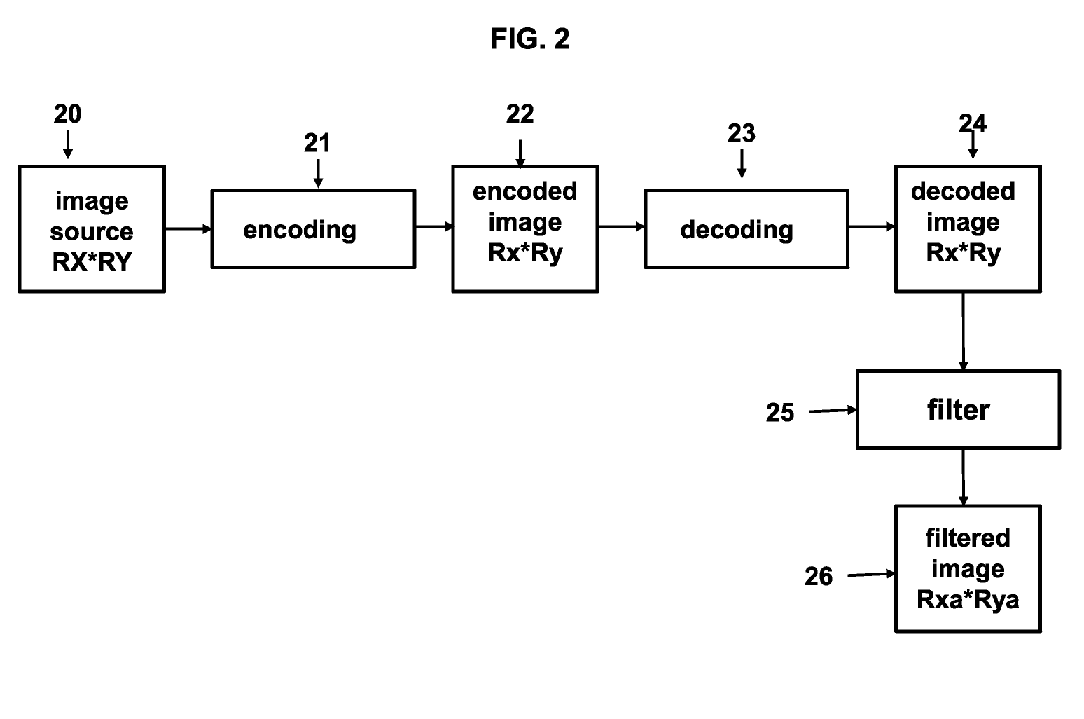

Mass distribution of digital images by networks of data transmission, including via the Internet or telecommunication networks, encounters, by the multiplication of the display and the proliferation of sources of diffusion devices, the general problem of adaptation of the dimension of the image to the resolution of the display device. Known methods for displaying an image on a digital display device, regardless of the dimension of the image and regardless of the resolution of the display device, are described diagrammatically in FIGS. 1 and 2.

The method most commonly used, described in FIG. 1 consists in a first step in applying to the source 10, an image of dimension Rx by Ry (number of pixels per line and number of Rx Ry lines), a modification 11 so that the size of the image after modification is equal or inferior to resolution of the device on which you want to display the image. By resolution of the display device, here defined as the maximum number of lines and pixels per line that this device is capable of displaying this modification 11 operates according to a known technique, for spatial filtering in one or two dimensions, that is to say by spatial interpolation of points of the image. We then obtain a filtered dimension Rxa by Rya picture. The modified image 12 is then encoded by an encoding method 13 determined next.

This method 13 may be selected from various known methods of encoding image, which increasingly uses compression techniques to reduce the bandwidth required for the transmission of images. This encoding process may be, for example: RLE encoding that proceeds by identifying and encoding sequences or identical patterns, GIF encoding that proceeds by reducing the number of color JPEG encoding that proceeds by averaging through adjacent points of a discrete cosine transform (DCT known under the abbreviation for Discrete Cosine Transform) and quantization and compression, MPEG encoding which involves detection of temporal correlations between successive images, and encoding differences between these successive images, or encoding by applying wavelet transform to the image, an iterative method, a decomposition of the image into sub-images of decreasing resolution before quantization and entropy coding.

The encoded image 14 is then transmitted to the display device 15, possibly via a communication network. Upon receipt of the encoded image 14, the display device 15 decodes encoded image, restoring a decoded image 16, which is suitable for its display resolution, and can display the decoded image. This type of solution however has the major drawback that the image source must undergo prior adaptation, before encoding, as regards its size and depending on the device on which it is desired to display.

This results in an image well suited and encoded, can be transmitted and displayed correctly on devices for which its size is suitable, which is an obstacle to a simulcast of the image to different types of devices display, such as simultaneous display on a computer resolution of 800 by 600 pixels, receiving image via Internet and a cell phone screen resolution of 200 by 150 pixels, receiving the image via a telecommunications network.

Another known method is described in FIG. 2.

The image display source 20 is here first encoded according to a known coding process 21, chosen, for example, from those mentioned above. The encoded image 22 is then transmitted to the display device 23, which decodes the image and thus generates a decoded image 24 having the same size as the original image. If this image is too small, or too large, a spatial filtering process 25, similar to that used in the process described in FIG. 1, is applied to the decoded image 24 and generates a filtered image 26, which is adapted to the dimension of the device resolution display.

This second type of process has the major drawback, as for example in the case where the display device is a mobile phone screen resolution of 200 by 150 pixels and the original image an image of size 4000 by 3000 pixels, a significant amount of memory is required to decode the image 22 before displaying this amount of memory being such that, in the cases of a mobile phone, it is simply not possible to decode the image.

The ultra low loss compression means therefore aims to provide a picture decoding method does not have the drawbacks mentioned above of the prior art and by decoding for rendering an image of adjustable size, depending on the particular needs of the user for or the display device to which it is intended, irrespective of the dimensions of the original image.

To this end the ultra low loss compression means relates to a method for decoding a digital image for generating, from a set of data resulting from the encoding of a first image by RX1 RY1 dimension, a second dimension image RXm by RYM, said data set comprising parameter value RX1 and RY1 giving the size of said first image, and one or more subsets of data, each subset of data being representative of a sub-image of level i of said first image, each sub-image having a resolution less than or equal to the resolution of said first image, each subset of data resulting from the processing by a reversible transformation, with or without loss, and reproducing said first image by applying the inverse to return a decoded sub-picture of said first picture, said method comprising the following processing steps: a) allocating a memory image whose resolution is at least equal to the dimension RXm RYM by said second image, b) replacing in said set of data values of RX1 and RY1 parameters giving the size of said first image by the values and RYM RXm giving the dimension of said second image, c) decoding each of said subsets of data and modified using said inverse transform to return said sub-image and assigning said decoded image data memory with said sub-image decoded to generate said second image.

For the same purpose the ultra low loss compression means also relates to a device for implementing the method according to the invention, including an image display device, and comprising means for allocating memory to perform step a) of said method and calculation means for performing the steps b) or c) of said method.

The images seen here are both images with a single channel (typically an image in grayscale) and images with multiple channels (typically an encoded 3-channel RGB or YUV color image), without restriction the user representation of information used for color or gray level.

By resolution image memory here refers to the maximum dimension of the image that memory may contain, apart from the number of bits per pixel, given that in this case said image memory is adapted to contain said second image and each data describing a point of the image is represented in said memory by a number of bits corresponding to the depth (or number of bits per dot) of the second image. On the other hand the said resolution of said image memory is at least equal to the dimension of said second picture.

It is understood here that the optimum position, from the viewpoint of reducing the amount of memory used, is where the resolution of said picture memory is equal to the dimension of said second picture. However, this resolution can be chosen to be greater—for example, in the case where the physical size of the allocated memory should be rounded up to 256 bytes—without any diminution of the smooth running of the process according to the invention.

The method and device of the ultra low loss compression means allows the limitation of the size of the memory allocated for the decoding of the image, regardless of the dimension of the original image. In addition, the decoded picture is representative of the original image as a whole, and not only a sub-portion that would have been cut out from this original image. According to a particular embodiment, the memory size allocated may be independent of the received image and be allocated permanently for all frames to be decoded.

Moreover, the method of the present invention avoids the adaptation step (spatial interpolation) as described above prior art as referenced in FIGS. 1 and 2. The process of scaling is integrated in the present invention very simply and without additional calculations in the decoding process.

Accordingly, the ultra low loss compression means according to the invention also offers clear advantages in terms of processing time.

In the claimed process, however, it is limited to data from a method of encoding of a certain class of encoding methods, those generating a data set composed of one or more subsets of data, such as each subset of data is representative of a sub-image of said first image, each having a sub-image resolution exceeding the resolution of said first image and such that each subset of data resulting from processing by the transformation is reversible, with or without loss, and enables the reconstitution of the first image by applying the inverse transformation of a sub-picture return to said first decoded picture.

These include sub-images and frequency components of a given frequency domain of the frequency spectrum of said first image and the frequency domain to which these frequency components belong is dependent on the nature of the applied transform. In the particular case of a wavelet transform, the resolution of the sub-frames is obtained decreasing regularly from level to level, which gives a good quality to the decoded image, the frequency components can be restored with a good fidelity compared to the original image. In the case of a set of sub-images of different resolutions, using the methods according to the invention, the sub-images may be adapted to restore the image to the output frequency spectrum of the image origin.

It is understood that if the size of the output image decoding and therefore its maximum resolution—is smaller than the original image, some frequency components cannot be restored to the maximum resolution of the output image. Advantageously, in such a case, the ultra low loss compression means of the present invention will provide the maximum possible resolution to the output image.

The known part of this category encoding methods are for example and typically the wavelet based methods or those based on strips.

Other methods of encoding, for example RLE encoding or JPEG DCT, do not reproduce images equivalent to the process according to the invention.

In the case of RLE encoding, changing dimension information in the data set will decode to limit the data to be decoded data representative of the first lines of the original image up to the number of pixels of the desired image output.

In the case of JPEG encoding of the type acting on the DCT sub-blocks of the image, because a local analysis of the image is performed—by segmentation of the image into blocks and applying the transform DCT on each block—changing dimension information in the data set to decode will effectively limit data will be decoded data representative of the first blocks of the image up to the number pixels of desired image output.

Devices have been disclosed that store medical image files in a jpeg, lossless jpeg, and RLE formats, but as taught in the present application, these file formats either do not compress the images or do not allow for the images to retain their diagnostic quality when decompressed. Using the ultra low loss compression means in a PeHR device of the present invention allow medical images to be compressed and reproduced in full diagnostic quality.

In the case of a wavelet transform-encoded strips or image, the method is also iterative, which means that each sub-image is generated from the wavelet transform of a respective strip of the higher sub-picture level. The ultra low loss compression means according to the invention, however, is not limited to this situation. In fact, any transformation, whether wavelet transformation strips or equivalent or derivative thereof, or of any other class, but still capable of generating sub-images of decreasing resolution of the original image, which can be restored by the inverse transformed, are suitable for implementing the ultra low loss compression means according to the invention.

In addition it is irrelevant in the implementation of the method according to the invention that the data representative of the sub-images are compressed or not to reduce the amount of data to transmit.

The ultra low loss compression means according to the invention is mainly applicable to single images, but may also be applied to image encoding methods using suites or transformed to meet the specifications outlined below are also within the scope of the method. For example, methods for decoding digital videos—in the manner of the MPEG2 method—an inter-picture temporal compression, but at least some of encoding images by a reference intra-frame encoding or intra-frame, however, may advantageously be used The image decoding method according to the invention for decoding the reference images and use the additional information from the encoding method selected for temporally interpolating these reference images.

In addition, the ultra low loss compression means according to the invention is equally applicable to the pre-encoded video and pre-recorded video as a stream of images encoded and streamed live on the fly (in streaming mode) and without phase prior registration. This video stream can be either continuous or real-time video stream (e.g. 25 frames per second) or discontinuous flow (e.g. sampled at 1 frame per second, for example in the context of a video device).

In the case of a display device incorporating the device of the ultra low loss compression means, it is possible to limit the size of allocated memory, and for example depending on the resolution of the display device either by for example by defining said second image size corresponding to the resolution of the display device, or by setting a limit being in a relationship with this resolution, for example an image having a size limit of 150% compared to the resolution of the device display, or finally, determining this size from a maximum memory available in the display device.

Methods to fix this limit may also depend processing means including display memory that is available in the system, spatial interpolation means, zoom or reduction means, or other means. In fact, if such means are present, a step of post-processing (or spatial interpolation truncation) or a particular display mode (through a zoom function) allows the best possible adaptation of the size of the decoded image to the display device, since the image has been decoded with a constraint on the size after decoding.

In such a case it is also possible to arrange for the dimension of the decoded image to best fit the resolution of the display device.

The ultra low loss compression means according to the invention may further comprise one or more of the following characteristics: it allocates for the treatment and/or storage of each of said data sets at least a memory area with a resolution at least equal to the dimension RYM RXm multiplied by the size of the second image; The dimension RXm RYM of the second image is adjusted according to the dimension RX2 RY2 multiplied by the size a third image and/or depending on the resolution of the sub-picture of lower resolution; The dimension RXm Rym multiplied by the size of the second image is greater than or equal to the resolution of said sub-image of lower resolution; Subsets of data are decoded by increasing the level of resolution in respect of the resolution of the sub image, each representative; It does not decode a subset of data that it is representative of a sub image, the horizontal resolution is less than or equal to the horizontal dimension of said second image RXm and the vertical resolution is less than or equal to RYM the vertical dimension of said second image; Said first image is an image having at least two color channels and in that said subset of data resulting from encoding each separate channel, the channels being decoded separately and successively in said image memory; A sub-image i +1 level is obtained by applying said transform to a sub-image of level i; Said transform is a wavelet transform or the like; said transformed is transformed into a strip or the like; Said second image has substantially the same width/height ratio than said first image; The method further comprises the step of generating said third image dimension by RX2 RY2 by spatial interpolation and/or truncation of said second image; The value of RXm/RX2 ratio is between 0.5 and 2 and the value of RYm/RY2 ratio is between 0.5 and 2.

The device of the ultra low loss compression means may also comprise one or more of the following features: said device further comprises image display means including an output memory, said third image dimension is less or equal to the resolution of said output memory and said device further comprises means for transferring, to the display, said third image to said output memory; Said frame memory is allocated to a maximum size by RXmax RYMAX dependent resolution of said output memory, independent of the size of said first image; Said display means comprise a predetermined number of display dots of image formats and in that said device further comprises means for adapting the size of dots of said third image to at least one of said formats display.

By the device and method of the ultra low loss compression means, the same data stream containing an encoded image can be displayed on different display devices, regardless of display resolution and regardless of the size of the original image.

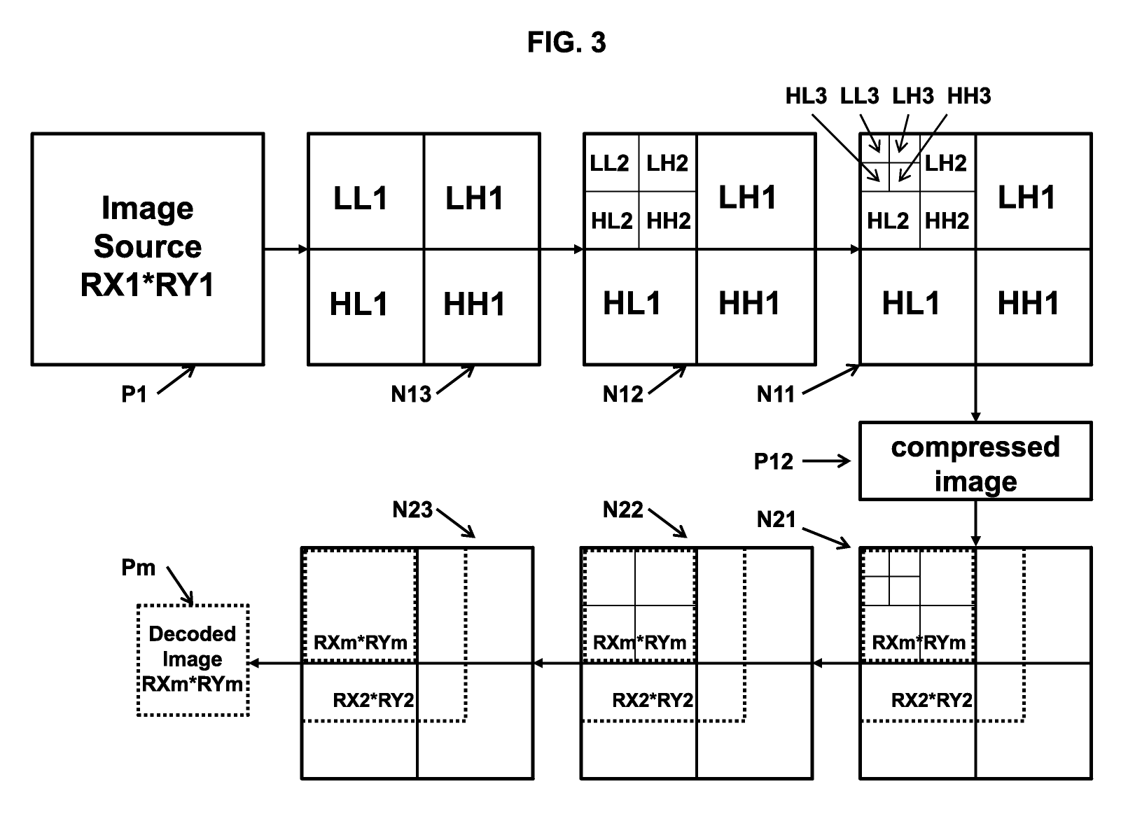

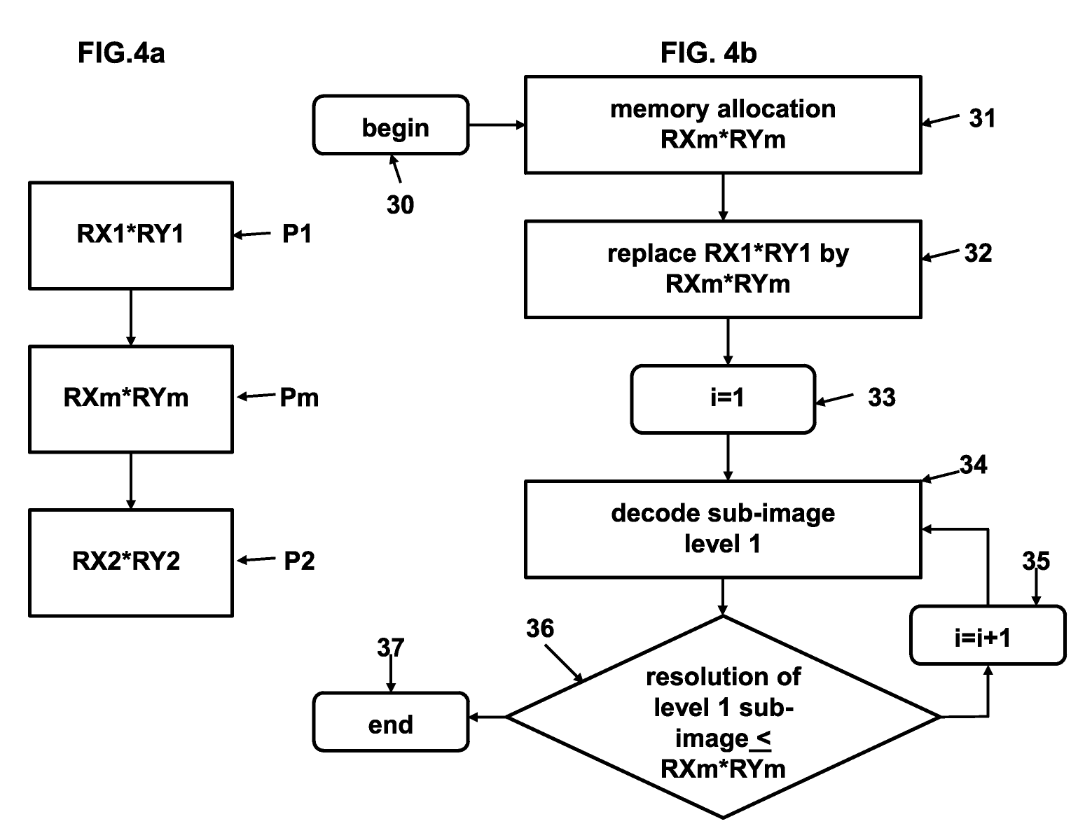

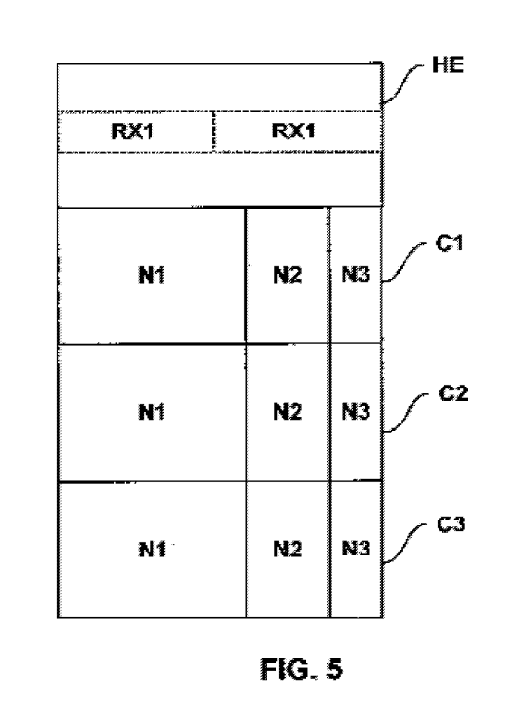

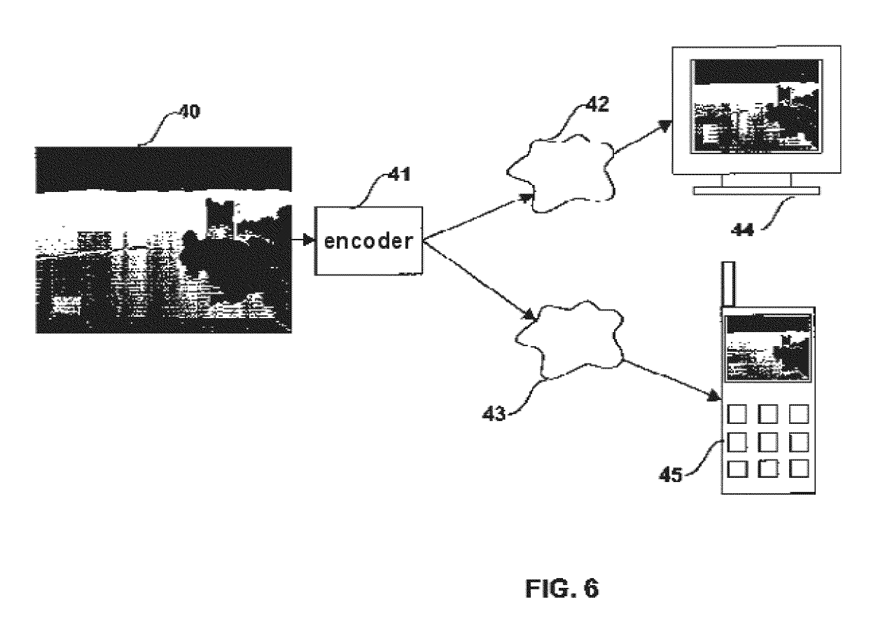

Other advantages and features of the ultra low loss compression means portion of the invention appear in the detailed description which follows and with reference to the figures in which: FIGS. 1 and 2 are known from the prior art processes have been described previously, FIG. 3 is an example of the image encoding method using a wavelet transformed base that can be used in the ultra low loss compression means portion of the invention, FIG. 4a schematically shows different images affected by the ultra low loss compression means portion of the invention, FIG. 4b is a flowchart of the ultra low loss compression means portion of the invention, FIG. 5 is a schematic representation of a subset of data used in ultra low loss compression means portion of the invention, FIG. 6 is an illustration of an exemplary application of the ultra low loss compression means portion of the invention.

In order to simplify the description, the detailed description of the ultra low loss compression means portion of the invention which follows will be given taking as a non-limiting embodiment where the encoding method is an encoding method by wavelet transform. The method according to the invention, however, is not limited to such processing, since all five transformations (e.g. transformed into strips) for generating a subset of data satisfying the requirements set out above are suitable for implementing the method.

A method for encoding wavelet transform is described schematically in FIG. 3.

This figure shows the processing steps applied on an initial image P1 by RX1 RY1 dimension.

In this picture is applied in a first step a first wavelet transform decomposes the image into 4 subsets of N13: LL1, LH1, HL1, HH1 data respectively representing low horizontal and vertical frequencies of the frequency spectrum of the P1 picture, vertical low frequency and horizontal high frequency of the frequency spectrum of the image P1, the low horizontal and high vertical frequencies in frequency spectrum of the image P1 frequency and horizontal high frequency and vertical frequency spectrum of image P1.

In a second step we apply to the subset LL1, corresponding to a low frequency of the P1 sub-image, a wavelet transform that decomposes the sub-image LL1 into 4 subsets: N12 LL2, LH2, HL2, HH2, respectively representing low horizontal and vertical frequencies of the frequency spectrum of the LL1 sub-picture, vertical low frequency and horizontal high frequency spectrum of the LL1 sub-picture, the low horizontal and high vertical frequencies in the spectrum frequency of the LL1 sub-picture, and high horizontal and vertical frequencies of the frequency spectrum of the LL1 sub-picture.

In a third step we apply to subset LL2, corresponding to a low frequency LL1 sub-image, a wavelet transform that decomposes the sub-picture LL2 4 subsets of N11 LL3 data, LH3, HL3, HH3, representing respectively low horizontal and vertical frequencies of the frequency spectrum of the sub-picture LL2, low and high frequency horizontal vertical spectrum frequency of the sub-picture LL2, low horizontal and vertical high frequency spectrum frequency the LL2 sub-picture, and high horizontal and vertical frequencies of the frequency spectrum of the sub-picture LL2.

At each of the three steps just described the wavelet transform decomposed the image into sub-images of decreasing resolution by level, successively from the N13 level (L1, LH1, HL1, HH1), the second level N12 (LL2, LH2, HL2, HH2) to the third level N11 (LL3, LH3, HL3, HH3). Each of these sub-images has a resolution of less than or equal to that of the original image P1, and is representative of frequency components of an area P1 of the determined frequency spectrum of the image P1. This frequency range is directly dependent on the nature of the applied processing.

The wavelet transform process is followed by a process of actual compression which is used to encode each of the subsets of data thus obtained, e.g. by using a quantization method coupled with entropy coding. This results in a compressed picture P12. According to the method of compression used herein, there may be information loss or not.

The compressed image is then decompressed P12, for example for display. Advantageously each subset of data is compressed independently of the other so as to not decompress some of these subsets. After decompression, the subsets LL3, LH3, HL3, HH3, LH2, HL2, HH2, LH1, HL1, HH1 are returned. The original image is restored from these subsets by applying the inverse transform to the one used for encoding wavelet subsets LL3, LH3, HL3, HH3 to restore the sub-picture LL2, subsets LL2, LH2, HL2, HH2 return to the LL1 sub-picture and finally the subsets LL1, LH1, HL1, HH1 to restore the source image of dimension P1 by RX1 RY1.

The ultra low loss compression means portion of the invention is now described with reference to FIGS. 4a and 4b.

When P1 receives a first image 30 coded, for example using the method of wavelet transform which has just been described, it allocates an image memory 31 which corresponds to the resolution RXm times RYM times second image (Pm) which is to be decoded. By resolution image memory here refers to the maximum size of the image that this memory may contain, apart from the number of bits per pixel. Thus a memory required for 800 by 600 resolution will likely be larger than the image size of 800 by 600 pixels, knowing that if the depth (or number of bits per pixel) of the image is 24 bits per dot, the physical size of the memory area number of bits will be 800*600*24.

In the case of the ultra low loss compression means portion of the invention, the image memory is adapted to contain decoded image Pm, and therefore has a depth equal to that of the image Pm. Moreover, in the general case, the depth of the second image after decoding Pm is the same as the original image P1.

In the available data representing the image coded Pi, and comprising representatives particular data subsets LLi, LHi, HLi HHi as described above, is information, in particular settings giving RX1 dimension RY1 the original image. These parameter values are replaced in 32 by the values RXm RYM giving the image size desired output Pm.

The decoding method provided for decoding of the image P1 by RX1 RY1 dimension continues by decoding the different subsets of data 34, and as if they were coming from an image of size RYM RXm. In this way the sub-images of image P1 encoded by these subsets LLi, LHi, HLi, HHi are decoded to generate sub-images of image Pm. In the case of a decoding method using a wavelet transform, the image size of Pm will necessarily be greater than or equal to the resolution of the sub-picture of lower resolution. This is not a limitation to the use of the ultra low loss compression means portion of the invention because it is possible to encode the original image in such a manner that it is divided in all cases into sub-pictures of very low resolution, eg sub-images having a resolution or size of 16 by 16 points.

According to a particular embodiment decoding subsets of data is done level by level, and preferably starting with the subsets corresponding to the sub-images of lower resolution, then proceeding in order of increasing resolution in relation to resolution sub-images. On the flow chart of FIG. 4b, the variable i is used to designate the initial resolution level 30. This level of resolution is initiated by example the value 1 in step 33 before proceeding with successive decoding steps. The level of resolution is increased incrementally in step 35 by one unit after each step of a decoding level.

In the particular case where the transform used is a wavelet transform, the width/height ratio of the image will be rendered substantially equal to Pm—since every time it decodes all the sub-images of the same resolution level.

For example if after the first two levels are fully decoded, that is to say the sub-pictures LL3, LH3, HL3, HH3, LH2, HL2 and HH2, and decodes it to the resolution level following the sub-picture LH1, an image twice as wide will be restored.

The horizontal dimension and vertical dimensions of the image are decoded in the case of a wavelet transform in a power ratio of 2 relative to the horizontal and vertical dimensions of the original image respectively. If the transform used is a wavelet transform, the maximum size of image Pm that is returned is that of the original image.

When the image is to be rendered and Pm has a lower dimension, either horizontally or vertically, than the size of the original image, it is not necessary to decode all the subsets of data, and un-decoded data will not be displayed. In such a case, it is determined in step 36, at each iteration, depending on the resolution of the sub-images and the current level compared to the size of the memory allocated by RYM RXm, whether it is necessary to continue the decoding process. For example for a Pm size image (RX1 RY1 times ½) as shown in dotted lines in FIG. 3, it will decode only the first 20 levels of two subsets, that is to say LL3, LH3, HL3, HH3, LH2, HL2 and HH2. Accordingly, the process according to the invention also has advantages from the standpoint of processing time, since only useful for the reconstruction of the image data will be decoded Pm.

Usually, in a wavelet decoding method, decoding of the sub-images can be effected in two different ways. First, if a sub-image size and resolution corresponds to the resolution of the image which it represents, it is restored for each subset. Second, an image of the same size as the output image but whose resolution corresponds to the resolution of the sub-image, is restored at the resolution of the sub-image. This second solution has the advantage of allowing progressive image display results. The decoding process proceeds iteratively until it produces an image of the desired size.

In the case of an image decoding method by applying a wavelet transform, the subsets of data representative of the sub-images are received in the form of wavelet coefficients. These subsets of data (or wavelet coefficients) shall, before being treated, be stored in memory for decoding. Due to the change of dimension parameters effected prior to the step of decoding which has been described above, the method of decoding (FIG. 3) usually used will allocate memory blocks having a corresponding resolution, not the size of the original image P1, but the dimension of the decoded image Pm. Of course, these memory areas or blocks may be allocated with a larger size without affecting the operation of the process according to the invention.

It is clear however that this is the lower limit for the usable size of these memory blocks that best reduce the amount of memory required for decoding method. These intermediate memory blocks represent a significant percentage (usually 50% to 90%) of the total amount of memory required for the decoding process. Thus according to the ultra low loss compression means portion of the invention, the amount of memory required for the decoding process will be greatly reduced.

In the case where it is desired to obtain a final image, P2, whose height/width ratio is different from that of the original image P1 and that the inverse transform used does not do so directly, a step of post-image processing Pm is necessary. This step may be, according to well known methods, either by interpolation in one or two dimensions or by a truncation of the edges of the image. In the example shown in FIG. 4a, and according to a particular embodiment of the after-treatment stage, the image P2 dimension RX2 by RY2 be obtained from the image Pm by interpolating additional points horizontally and vertically, which will provide an image P2 that is slightly larger than Pm.

According to another embodiment of the step of post-processing, and by reference to the example of FIG. 3, the decoded image Pm will have the same size as the original image P1 (RX1 RY1) by decoding all subsets LL3, LH3, HL3, HH3, LH2, HL2, HH2 and LH1, HL1 and HH1. In this case the interpolation step will be to reduce the image size for Pm to dimension RY2 by RY2. This second method gives better resolution in the final image.

Alternatively we can decode only the subsets LL3, LH3, HL3, HH3, LH2, HL2, HH2 and LH1 to generate the widest image original image, but twice as high. In this case the interpolation step will be to reduce the horizontal dimension, respectively increasing the vertical dimension of the image Pm to the RY2 by RY2 dimension.

Since in the case of a wavelet transform one is forced to keep—outside the post-processing step—the width/height ratio of the original image or to change of a factor power of 2, we retain the maximum level of resolution needed to give a better quality image and choose between one of two methods of post-treatment (reduction or enlargement of the image Pm).

According to a particular embodiment of a ultra low loss compression means portion of the invention, further comprising a display means having a display resolution of Y given X, the decoded picture Pm is limited to a maximum size corresponding to a resolution twice that of the display means. This means that the maximum allocated image memory, RXmax, =2*X*Y=2*RYMAX this memory image can then be used to decode all images received whatever size of the original image.

In another embodiment, it allocates memory image to the size RXm by RYM of the desired image Pm, which keeps the width/height ratio of the original image and is closest in size to the resolution of display device.

Thus the size of the image Pm is adjustable according to the use we make of it, in particular depending on the resolution of the display device on which the decoded image Pm or P2 is intended to be viewed, or depending on the exact size of the desired image P2.

This adjustment must, especially in the case of a wavelet transform, also consider that if the resolution of the sub-image is lower, the image size Pm cannot be lower. This adjustment is done by comparing the height/width of the original image P1 and that of the desired final image.

According to one particular embodiment, an adjustment will be made to an image Pm having a height/width ratio equal to P1 and selected according to the size of the desired image P2, that is to say such that the ratio RXm/RX2, RYm/RY2 respectively, has a value that is within a given range, for example between 0.5 and 2.

It is also possible that in the case of large discrepancy between the height/width ratios of P1 and P2, that the image Pm will have a height/width ratio which is more than a power factor of 2 greater than P1, said factor being chosen to obtain the desired aspect ratio for P2.

The adjustment just described with respect to the image P1 may instead be performed with respect to a sub-images, in particular with respect to the sub-image of lower resolution already considered above as the minimum image size Pm. This sub-image retains at least in a first approximation the width/height ratio of the original image, and is determined very directly—by successive multiplications by 2, and with consideration of the rounding mechanism—give possible dimensions for the image Pm after decoding. However it may be noted that the operation of scaling between Pm image and image P2 may be unnecessary if the display device for displaying the final image has a vertical zoom function and/or an integrated horizontal (achieved electronically, for example).

A device for implementing the ultra low loss compression means portion of the invention comprises: a means for storing image data in a memory, a means for allocation of the memory, a calculation means, a display means, and a decoding means to reproduce the image in the correct format before picture display. The final image P2 must have a corresponding resolution (less than or equal) to that of the display device so as to be transferred to the output of said memory device. It may be necessary to make a conversion to the format of each item of the image, in the case where the display device is not capable of displaying any type of format paragraph (8 bits, 16 bits, 24 bits, 32 bits, etc.). This conversion step utilizes the known color space conversion algorithms, quantification, projection, etc. and are not further described here. When the formatting is completed, the image display can then be transferred to the output buffer of the display device to be finally displayed.

In FIG. 5 there is shown schematically an example of a representative of a set of encoded by a wavelet transform image data. This data set consists of different data blocks. The first block is a header HE comprises information relating to these data, parameters including giving the size of the original RX1 and RY1 picture. The image in this example is a color image with three color channels. It is for example defined in the RGB color image space (Red, Green, Blue) with a channel for the red component R, a channel for the green component G and a blue channel for the B component. It may have an image with a channel for luminance and also two for chrominance in a color space YUV (or YCrCb, widely used in the world of video) or the type defined in a HLS (Hue image space, Light saturation or hue, luminance, saturation color space widely used in the world of graphics). A channel therefore relates both to luminance information, saturation, or hue of color component, or any other specific information resulting from encoding of a color space or a gray level.

In the example of FIG. 5, the following three blocks of data C1, C2, C3 are each a color channel, the data being encoded in this example channel by channel. In each channel C1, C2, C3, are encoded successively different subsets N1, N2, N3 10 each corresponding to a given level of resolution of a given channel. Advantageously, the levels of low resolution are encoded first. In this way we can begin to decode a channel C1 starting from the N1 level, lower resolution. With reference to the example of FIG. 3, the N1 level includes subsets LL3, HL3, LH3 and HH3. The following levels are then treated until the resolution of a level reaches or exceeds a level of that of the image to be rendered, as described above. Advantageously, it has a pointer to each of the first three levels N1 channels, so that if one does not decode all levels of resolution, it can directly treat the next channel without having to read the remaining data for the channel.

This particular embodiment allows for sequentially processing channels, and thus help limit the size of the memory it is necessary to allocate. In this embodiment, a single image memory having the depth image Pm (which in the general case is that of the original image P1) is used to store data after decoding different image channels Pm. Regarding the sub-data sets (corresponding in the case of a wavelet transform to the wavelet coefficients), they are stored in memory areas whose depth (the number of bits required to describe each data) depends on the mode of representation of these coefficients (integer representation or representation floating precision) and the number of bits used in this mode of representation (typically 16, 32 or 64).

FIG. 6 shows schematically an exemplary application of the ultra low loss compression means portion of the invention. It has an image source computer terminal 40, and it is desired to simultaneously transfer the image to a customer information terminal 44 and a mobile phone 45. The customer information terminal is in communication via a network 42, for example the Internet, with the source computer terminal. The mobile phone is connected via a second communication network 43 with the computer terminal source. The content of the information conveyed by the two networks are identical and the result of the operation of the encoder 41.

The source computer terminal 40 therefore has no need to make adjustment according to the type of receptor or the type of network used for transmission. The customer information terminal 44 as well as the mobile phone 45 are capable, by implementing the method according to the invention, to perform decoding of the data stream transmitted by the source data terminal. A person is therefore able to receive images on his computer terminal, and if he should move may still continue to monitor the issue of images by using his cell phone since it is also capable of receiving digital data stream from the source terminal.

The ultra low loss compression means portion of the invention may for example be operated in an application such as diagnosis, wherein a doctor can receive medical images either on a fixed computer terminal or his mobile phone.

According to another example of the implementation method of the invention, is adapted to be used in such a video surveillance application, wherein the images are transmitted directly to various control terminals, both fixed computer terminals and mobile devices such as mobile phones or PDA's, allowing users to monitor continuously issuing CCTV images, either from a station or on the move.

I claim:

1. A portable device for storing and transporting personal electronic health records comprising a memory storage device, an ultra low loss compression means, and a security system for protecting the confidentiality of the patient information.

2. The portable device of claim 1 wherein the ultra low loss compression means compresses and decompresses medical images so that they retain their diagnostic level quality.

3. The portable device of claim 1 wherein said memory storage device is selected from the group consisting of a USB flash drive, a wireless USB flash drive, and an SD card.

4. The portable device of claim 1 wherein said memory storage device is connected to another electronic device by wired or wireless means.

5. The portable device of claim 1 wherein the security system comprises password protection software.

6. The portable device of claim 4 wherein the password protection software comprises a dual authentication password protection software.

7. The portable device of claim 1 wherein the security system comprises encryption of all patient data.

8. The portable device of claim 1 wherein the security system comprises a memory storage device containing a physical lock.

9. The portable device of claim 7 wherein the physical lock is a combination lock.

10. The portable device of claim 7 wherein the physical lock comprises a keypad allowing a code to be entered manually.

11. The portable device of claim 1 wherein the memory storage device is a patient controlled device.

12. The portable device of claim 1 wherein the ultra low loss compression means comprises a decoding method for generating a digital image, from a set of data resulting from the encoding of a first image of RX1 by RY1 dimension, a second image of RXm by RYM dimension, said set of data comprising parameters RX1 and RY1 values giving the size of said first image and one or more subsets of data, each subset of data being representative of a level sub-image i from said first image, each sub-image having a resolution less than or equal to the resolution of said first image, each sub-set of data resulting from the processing by a reversible transformation, with or without loss, and allowing said first image by applying the inverse transform to reproduce a decoded sub-picture said first image, said method comprising the steps of: a) allocating a memory image whose resolution is at least equal to the dimension RXm by RYM of said second image, b) replacing in said set of data values of the parameters and RXI RY1 giving the size of said first image by giving RYM RXm values and the dimension of said second picture, c) decoding of each of said subsets of data and modified using said inverse transform to return the said sub-image decoded and then assigning said image memory with data from said decoded sub-image to generate said second frame.
